(19) United States
(12) Patent Application Publication
(10) Pub. No.: US 2026/0087921 A1
(43) Pub. Date: Mar. 26, 2026

(54) SENSOR AND SYSTEM FOR MONITORING

(71) Applicant: MariElectronics Oy, Vantaa (FI)

(72) Inventors: Juha LINDSTRÖM, Espoo (FI); Göran SUNDHOLM, Tuusula (FI)

(73) Assignee: MariElectronics Oy, Vantaa (FI)

(21) Appl. No.: 19/111,610

(22) PCT Filed: Aug. 8, 2023
(86) PCT No.: PCT/FI2023/050457

§ 371 Date: Mar. 13, 2025

(30) Foreign Application Priority Data
Sep. 14, 2022 (FI) 20225797

(51) Int. Cl. G08B 21/04; G10L 13/02; G10L 15/183

(52) U.S. Cl. CPC G08B 21/0492; G08B 21/043; G08B 21/0469; G10L 13/02; G10L 15/183

(57) ABSTRACT

A system includes at least one sensor, a means for processing the measurement signal of the sensor and means for communicating measurement results and/or data relating to the measurement results for further processing. The system includes means for producing and capturing audio and the system is configured to determine with the at least one sensor that the safety of a monitored person is endangered and based on the determined endangered safety of the monitored person, to use the means for producing audio to initiate a speech dialog with the monitored person, and to use the means for capturing audio to listen to the reply from the monitored person. Based on the captured audio the system assesses the situation and determines if an action is required, the system being configured to use a large language model for carrying out the speech dialog with the monitored person.

### FIELD OF THE INVENTION

The invention relates to a method and to a system, by means of which a person in a monitored area can be observed, tracked and/or the condition and safety of the person can be monitored.

### BACKGROUND OF THE INVENTION

The monitoring of the condition of elderly people in a home environment is indispensable, if it is desired to lengthen the possibility of an aging population coping in their home environment. Safety bracelet systems are nowadays widely used for these kinds of applications. Their weakness is that the user must wear the bracelet continuously and must be able to press the alarm button in an emergency. There are also bracelets that check the state of health of the user, but they have the same problems as described above, and additionally, there are further problems with false alarms.

There have also been presented solutions, in which a film of piezoelectric material is installed on the floor, in which the film registers pressure changes caused by movement on the surface of the floor. Also known in the prior art is the use of sensors to be installed on the floor, or under it, that detects the presence and movements of people, without requiring a change in pressure, but functions by means of capacitive sensors.

The possibility of using video cameras, movement detectors that are based e.g. on detecting infrared light, or e.g. ultrasound sensors, for monitoring the condition and state of elderly people is also presented in prior art. For example, WO2012164169 document discloses a method and a system that are based on ultrasound technology for tracking objects.

Some prior art solutions are known, which use millimeterwave (MMW) radar for tracking persons.

A drawback of observation and monitoring systems of the prior art is that they often interpret that a person needs help also in cases when external help is not necessary. In these cases, a person can for example be determined as fallen and a fall related alarm is given even if the person has not fallen or is able to get up without any help. These false alarms cause high costs for the companies being responsible for monitoring safety of the person or for the persons themselves who are monitored as the monitored person has to be contacted, e.g. by a professional caregiver, to check whether the person needs help. For these reasons there's a need for a reliable monitoring system which minimizes the number of false alarms.

### BRIEF DESCRIPTION OF THE INVENTION

By using the system, according to claim 1 and the method, according to 9, the problems of the state of the prior art can be eliminated. The invention is characterized by what is disclosed in the claims.

The invention relates to a system for observing the presence, location, movement and/or attitude of a person in a monitored area. The system comprises at least one sensor, a means for processing the measurement signal of the sensor, such as measuring electronics, and means for communicating measurement results and/or data relating to the measurement results for further processing. The system further comprises means for producing and capturing audio. The system is configured to determine with the at least one sensor that the safety of a monitored person is endangered, based on the determined endangered safety of the monitored person, to use the means for producing audio to initiate a speech dialog with the monitored person, and to use the means for capturing audio to listen to the reply from the monitored person, and based on the captured audio to assess the situation and/or to determine if an action, such as an alarm, is required.

In one embodiment of the invention the system is configured to use a large language model (LLM) for carrying out the speech dialog with the monitored person.

In one embodiment of the invention the system is configured to provide an initiation prompt to the large language model relating to the context of the monitored person and/or the monitored area.

In one embodiment of the invention the prompt relating to the context comprises at least one of the following: information about the role and the task of the large language model (LLM) in the speech dialog, information about the person being monitored such as the name, the physical condition and the level of assistance needed, the current situation as determined with the at least one sensor, the conditions under which an alarm is warranted, instructions on how the LLM should interact with the rest of the system.

In one embodiment of the invention the means for producing audio comprises a text-to-speech algorithm for converting textual output from the system to audible speech for the person being monitored, the means for capturing audio comprises a speech recognition algorithm for converting audible speech from the person being monitored to textual input for the system, and wherein the textual output of the system is connected to the input of the large language model (LLM) and textual input of the system is connected to the output of the large language model (LLM).

In one embodiment of the invention the system comprises at least one of the following sensor or sensors: a radar sensor, a floor sensor, a motion detector and/or a camera.

In one embodiment of the invention the means for producing audio is a speaker and/or the means for capturing audio is a microphone or a microphone array.

In one embodiment of the invention the system is configured to determine the safety of the monitored person to be endangered when the system has determined that the monitored person has fallen, is lying on the floor, is staying too long in certain part of the monitored area, such as a bathroom or a bed, is not eating or exercising and/or is going to certain part of the monitored area, such as to the balcony, during the winter.

In one embodiment of the invention the speech dialog initiation comprises of a question or a suggestion to the monitored person.

In one embodiment of the invention the system is configured to process the captured audio with a speech recognition algorithm to transform the captured audio to a text response.

In one embodiment of the invention the system is configured to compare the text response to a set of keywords for the situation assessment.

In one embodiment of the invention the action comprises sending a notification or an alarm with a description of the situation and/or the contents of the dialog.

The invention relates also to a method for observing the presence, location, movement and/or attitude of a person in a monitored area with a system which comprises at least one sensor and a means for processing the measurement signal of the sensor, such as measuring electronics, means for communicating measurement results and/or data relating to the measurement results for further processing and means for producing and capturing audio. The method comprises determining with the at least one sensor that the safety of a monitored person is endangered, based on the determined endangered safety of the monitored person, using the means for producing audio to initiate a speech dialog with the monitored person, and using the means for capturing audio to listen to the reply from the monitored person, and based on the captured audio assessing the situation and determining if an action, such as an alarm, is required.

In one embodiment of the invention a large language model (LLM) is used to carry out the speech dialog with the monitored person.

In one embodiment of the invention an initiation prompt is provided to the large language model relating to the context of the monitored person and/or the monitored area.

In one embodiment of the invention the prompt for context information comprises at least one of the following: information about the role and the task of the large language model (LLM) in the speech dialog, information about the person being monitored such as the name, the physical condition and the level of assistance needed, the current situation as determined with the at least one sensor, the conditions under which an alarm is warranted, instructions on how the LLM should interact with the rest of the system.

In one embodiment of the invention the means for producing audio comprises a text-to-speech algorithm for converting textual output from the system to audible speech for the person being monitored, the means for capturing audio comprises a speech recognition algorithm for converting audible speech from the person being monitored to textual input for the system, and wherein the textual output of the system is connected to the input of the large language model (LLM) and textual input of the system is connected to the output of the large language model (LLM).

With the above-described solution of the invention, a monitoring system is provided which is able to provide reliable measurement results in different kind of circumstances and which is easy install and maintain. One advantage, among others, is that the system is able to reliably observe safety of the people in the monitored area and at the same time to minimize the number of false alarms as the person is asked, via an automated speech dialog, whether he or she need help.

Various other advantages will become clear to a skilled person based on the following detailed description.

The terms “first”, “second” and “third” are herein used to distinguish one element from other element, and not to specially prioritize or order them, if not otherwise explicitly stated.

The exemplary embodiments of the invention presented herein are not to be interpreted to pose limitations to the applicability of the appended claims. The verb “to comprise” is used herein as an open limitation that does not exclude the existence of also unrecited features. The features recited in dependent claims are mutually freely combinable unless otherwise explicitly stated.

The novel features which are considered as characteristic of the invention are set forth in particular in the appended claims. The invention itself, however, both as to its construction and its method of operation, together with additional objectives and advantages thereof, will be best understood from the following description of specific embodiments when read in connection with the accompanying drawings.

### BRIEF DESCRIPTION OF THE FIGURES

The invention is illustrated with the following drawings, of which:

FIG. 1 presents the components of one example embodiment of the system of the invention, in the area to be monitored,

FIG. 2 presents the operation of one example embodiment of the system of the invention,

FIG. 3 presents an example embodiment of a sensor, according to the solution of the invention,

FIG. 4 presents one example embodiment of the system, according to the invention,

FIG. 5 presents an example of a processing pipeline of the system, according to one embodiment of the invention, and

FIG. 6 presents one example embodiment of the system, according to the invention.

### DETAILED DESCRIPTION OF THE INVENTION

In the solution of the invention the sensors can detect presence and movement of an object in the monitored area. The monitored object can be e.g. an elderly person or some other person benefitting from supervision. The sensor can be installed on the area to be monitored to which the object has access. In one embodiment of the invention the sensor can also be used to observe vital functions of the monitored person, such as the breathing, e.g. breathing frequency, and/or the heart beating rate of the person.

In the solution according to the invention, the system comprises at least one sensor and can further comprise measuring electronics producing sensor observations by means of the sensors, and a processor configured to process the sensor observations, and/or a central unit comprising a memory, which the central unit is e.g. a data processing device. For the purposes of this function, the central unit of the system can comprise the necessary software and information about the characteristic properties of the signals being detected. In general, the measuring electronics and/or the central unit can deduce information from a signal received via a sensor. The system can have a central unit, which can manage one or more sensors or sensor groups. In one embodiment of the invention, one sensor group comprises e.g. the sensors in the same space, such as in the same room.

An area to be monitored with sensors can be the whole area where the person is usually present or only a part of some area. The area to be monitored can comprise e.g. of one or more rooms and certain parts of the area, e.g. fixed installations such as cupboards, can be left outside the area to be monitored. In one embodiment, in which a sleeping person is monitored, the sensor can be arranged in connection with the bed, above the bed and/or beside the bed so that the monitoring area of at least one sensor covers at least a part of the bed or a person lying on the bed.

In the solution according to the invention, the sensor detects persons in the monitored area and measures and detects the location, velocity and/or shape of the monitored person. In one embodiment of the invention the sensor is configured to observe the object based on signal strength and/or by filtering out probable false measurement results.

The sensors can comprise at least one of the following: a radar sensor, a floor sensor, a motion detector and/or a camera. In one embodiment, the system comprises at least two sensors and is configured to detect and measure the persons in the monitored area based on the measurement signal of at least two sensors, which can monitor the same area and/or a different part of the monitored area. For example, the measurement area of the sensors can overlap for example at a certain part of the area.

The components of the system can be integrated into a single unit, e.g. into a sensor arrangement comprising the components of the system. In one embodiment of the invention a sensor arrangement can comprise at least some of the following components in a single unit: a sensor, a means for processing the measurement signal of the sensor (such as measuring electronics), a means for communicating measurement results and/or data relating to the measurement results for further processing and means for producing and capturing audio.

The sensor can be installed on a stand, on a surface, e.g. on a wall, door, floor or ceiling, and/or in the proximity of a surface, such as e.g. floor surfaces, wall surfaces, door surfaces or ceiling surfaces of an apartment and/or of the area to be monitored to which the object has access. In one embodiment of the invention the sensor or sensors are installed in the corner of the space to be monitored right below the ceiling tilted towards the center of the space. A typical tilt angle can be e.g. 15 degrees which can give the sensor a good view over obstacles such as furniture. In one embodiment of the invention the sensor or sensors are installed on a wall or in a corner of the space to be monitored, typically above the floor-level plane, e.g. at a height of approx. 40-150 cm from the floor. The field of view of the sensor can be e.g. approx. 90 degrees on the horizontal plane.

The system further comprises at least one means for producing audio and at least one means for capturing audio. The means for producing audio can be e.g. a speaker and/or the means for capturing audio can be for example a microphone or a microphone array.

In one embodiment of the invention the system can utilize normal household audio equipment, such as a Bluetooth speaker or a wireless speaker, as the means for capturing and producing audio.

In one embodiment of the invention the system is configured to use a VoIP speaker phone as the means for producing and capturing audio to allow audio dialog over the internet.

The system can determine with the at least one sensor that the safety of a monitored person is endangered. Based on the determined endangered safety of the monitored person, the system can use means for producing audio to initiate a speech dialog with the monitored person and use the means for capturing audio to listen to the reply from the monitored person. Based on the captured audio the system can assess the situation and to determine if an action, such as sending a notification or making or sending an alarm, is required.

In one embodiment sending an alarm or notification comprises sending a message to a person and/or an organization monitoring the health of the person, e.g. as a message to a phone, to a nurse, to relatives or to an emergency center. In one embodiment the speech dialog initiation comprises of a question or a suggestion to the monitored person, e.g. so that the person is asked if he or she is ok and/or if he or she needs help. In one embodiment of the invention, if no response is received from the person, an alarm or notification is sent because the system is unable to verify that the monitored person does not need help.

In one embodiment of the invention the system can process the captured audio with a speech recognition algorithm to transform the audio to a text response. In one embodiment of the invention the system can compare the text response to a set of keywords for the situation assessment. A notification or an alarm can be sent with a description of the situation and/or the contents of the dialog.

In one embodiment of the invention the system is configured to submit the captured audio to an external server or service, e.g. a cloud-based speech recognition engine, for speech to text translation.

In one embodiment of the invention the system is configured to produce the audio prompts with an external, e.g. a cloud-based, text to speech service.

In one embodiment of the invention the sensor or system is configured to do sentiment analysis to the captured audio and/or the text response for the situation assessment. In one embodiment of the invention the system is configured to do sentiment analysis of the text response with an external server or service, such as a cloud-based sentiment analysis service.

In one embodiment of the invention the means for producing audio is used with a text-to-speech algorithm to convert textual output from the system to audible speech for the person being monitored.

In one embodiment of the invention and the means for capturing audio is used with a speech recognition algorithm to convert audible speech from the person being monitored to textual input for the system.

In one embodiment of the invention the textual output and input is connected to the input and output of a large language model (LLM). The large language model can be e.g. an artificial neural network trained to generate natural language from a given context. A large language model (LLM) can be trained using self-supervised learning and/or semi-supervised learning, e.g. containing tens of millions to billions of weights. Large language models can work by taking an input text and repeatedly predicting the next token or word.

In one embodiment of the invention the large language model (LLM) is used to carry out the speech dialog with the monitored person. The large language model (LLM) can be provided with a special prompt to provide the context, e.g. context of the monitored person and/or the monitored space, to initiate the dialog. In one embodiment of the invention the dialog can be started by describing the current situation for the large language model (LLM), for example based on observations from the at least one sensor.

In one embodiment of the invention the prompt guides the large language model (LLM) to take the role of a virtual nurse or an assistant whose responsibility is to check the condition of the person being monitored when the system has determined that their well-being might be compromised. The prompt may include additional context such as information related to the condition of the person being monitored, the level of assistance needed and/or conditions under which an alarm is warranted. Furthermore, the prompt instructs the large language model (LLM) to generate its responses in a structured manner that can be used to drive or control the rest of the system. The instructions of the desired syntax can be given as few-shot examples of the interaction.

In one embodiment of the invention the conditions under which an alarm is warranted include the case where the system has detected a fall and the person being monitored answers positively or does not answer at all when asked by the large language model (LLM) if they need help. In the case where the system has detected a fall and the person being monitored answers that he or she does not need help, an alarm is not necessary and is not made.

In one embodiment of the invention the structured responses from the large language model (LLM) comprise commands to the rest of the system. Such commands can be for example “SAY <text>” triggering the text-to-speech system to output the speech audio corresponding to “<text>” based on the command from the large language model and/or “ALARM” triggering the delivery of an alarm. These (above and below presented) commands are only examples of the structural responses and other predefined responses or commands and/or response protocols such as JSON messages or function calls can be used.

The system can in one embodiment of the invention to determine that the safety of the monitored person to be endangered when the system has determined that the monitored person has fallen, is lying on the floor, is staying too long in certain part of the monitored area, such as a bathroom or a bed, is not eating or exercising and/or is going to certain part of the monitored area, such as to the balcony during the winter. The system can in one embodiment of the invention to determine that the safety of the monitored person to be endangered when if the vital functions of the monitored person, such as tracked heartbeat and/or the monitored person's breathing, is not within the predefined limits.

In one embodiment of the invention, fixed objects, such as beds or sofas, where the person can lay down, can be determined by the user with the sensor and/or a sensor system, and the sensor does not determine the person as fallen in the areas of these fixed objects. In one embodiment of the invention, the sensor can distinguish objects from the observed persons by the determined elevation of the observed object, e.g. in such a way that when the elevation of the determined objects is essentially constantly under a certain threshold elevation value, the object can be recognized as not being a person.

In some applications, it is advantageous to first chart the unchanged area, i.e. to chart the measuring information of the sensors when mainly stationary and unmovable objects and structures are in place. This type of situation is e.g. in a residential apartment when the furniture is in position but there are no people, pets or robots in the apartment. This charted information can be recorded in the system, e.g. in a memory that is located in the central unit or in a memory means that is in connection via a data network, which memory means can be e.g. in a control center or service center. For this purpose, a memory means can be integrated into the sensor or the system, so a memory means can be in the central unit or connected to it via a data network.

According to one embodiment of the invention, the system charts the unchanged area continuously or at defined intervals, in which case the system is able to detect e.g. changes in the area caused by new furniture or by changes in the location of furniture. In this way the system is able to adapt gradually to changes occurring in the area to be monitored.

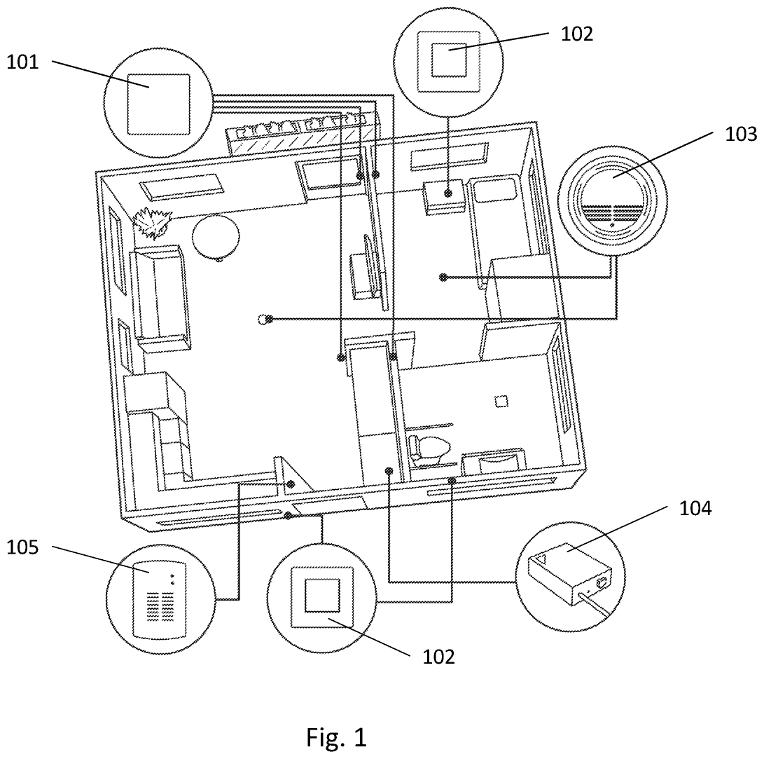

FIG. 1 presents the components of an exemplary embodiment of the system in the area to be monitored. The sensor 101 or sensors to be used in the invention are arranged in connection with the area to be monitored in such a way that the area to be monitored can be monitored by with the sensor 101 or sensors. Sensors can be installed on top of a surface, e.g. a wall, floor or ceiling surface, and fastened to the surface e.g. with double-sided tape or with a sticker strip, in which case they can easily be removed. The sensors 101 can be connected wirelessly or by wireline to the gateway 104, which collects measured values obtained from the sensors 101 or status information formed by the sensors 101, e.g. the objects detected, the state of health of the objects, such as persons, and/or the movement and attitudes of the objects.

The system can comprise at least one means for producing audio 105, e.g. a speaker, and/or at least one means for capturing audio, e.g. a microphone or a microphone array. The means for producing audio and/or the means for capturing audio can be integrated to the sensor 101 and/or the means for producing audio an/or the means for capturing audio can be separate units.

The gateway 104 can send the information onwards e.g. to a control center or to another organization that supervises the area and/or the objects, such as persons, therein. The transfer of information between the system and some recipient can be performed e.g. using a phone connection, a wireline broadband connection or wireless connections. It is advantageous in the data transfer to take into account issues relating to data security and privacy, which many official regulations also address.

In one embodiment of the invention, the sensor 101 or sensors comprise their own central unit and the central unit of a sensor is in connection with the gateway 104. In a second embodiment of the invention, the central units of the sensor 101 or sensors are integrated into a gateway 104.

It is possible that some of the functions of the central unit or of the gateway 104 are performed elsewhere via a data network connection, e.g. in a central control room or service center, such a server or cloud service.

The system, according to the invention, can also comprise a call pushbutton 102. After pressing the call pushbutton, the system can connect to e.g. nursing personnel, security personnel, or it can perform various alarm procedures. The call pushbutton can be wireless, and it can be adapted to function without batteries.

The notification procedures and alarm procedures, according to the system of the invention, can include e.g. activating a local alarm, indication signaling (such as a buzzer, light, siren, alarm clock, etc.), making contact with an alarm center or service center, a care provider or a relative. In some cases, an alarm can also be sent directly to the person being monitored or to the user, e.g. by means of speech synthesis or a speech recording. For performing these tasks, the sensor or the system can comprise means needed for processing time data, such as e.g. a clock circuit.

According to one embodiment of the invention, in addition to speech dialog, an alarm signal can be given by the system in the space being monitored, which lasts a predetermined period of time. This alarm signal can be given as a local alarm, e.g. before the sending of an alarm or notification, and it can be given via a light alarm unit and/or a sound alarm unit of the system. The light alarm unit and/or sound alarm units can be in each different part, e.g. a room of the premises. This functionality can also be integrated into the sensors, e.g. into all the sensors or only some of the sensors.

The system, according to the invention, can also comprise fire detectors 103, which can be in connection with another system via a wireline or wireless connection. If the fire detectors 103 warn of a fire, alarm procedures can be performed, e.g. by sending an alarm message to a control center or to the rescue authorities.

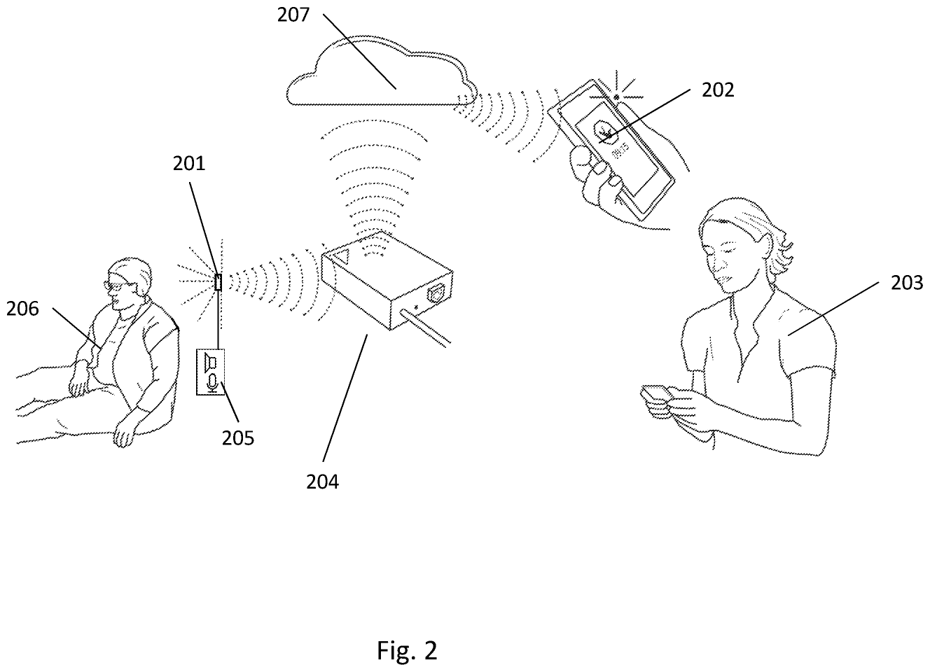

FIG. 2 presents the operation of an embodiment of the system, according to the invention, in which the state of health or attitude of a person 206 in the monitored area is monitored.

If the sensors 201 of the system detects that the safety of a monitored person 206 is endangered, the system can initiate a speech dialog with the monitored person with means for producing audio and listen to the reply from the monitored person 206 by using the means for capturing audio. Based on the captured audio the system can assess the situation and to determine if an action, such as sending a notification or making or sending an alarm, is required. In the example of FIG. 2 the means for producing audio and the means for capturing audio can be integrated to the sensor 201.

In one embodiment of the invention, the system examines the information measured by a number of sensors, e.g. by all the sensors in the area being monitored, and a notification, e.g. a remote alarm, is only sent and/or a speech dialog is only initiated if no other persons are detected in the area by the sensors.

In the situation in the embodiment presented in FIG. 2, in which the system sends a message e.g. based on the speech dialog, based on falling of a person and/or because of determined vital functions of the person, the sensor 201 sends the information about the situation to the gateway 204 of the system and the gateway 204 sends the information and/or an alarm onwards to the server 201 e.g. via an Internet connection or via some other connection. From the server 207, the information and/or alarm is sent to a organization monitoring the health of the person, e.g. as a message to a mobile phone 202, as an alarm and/or e.g. to a nurse 203, to relatives or to an emergency center. In this way, for example information about the person reaches the necessary people or organizations and the person who fell receives help as quickly as possible. In one embodiment of the invention, the system can send information directly from the gateway 204 to an organization or a person monitoring the health of the monitored person. In this example the monitored person can have stated in the speech dialog with the system received by the means for capturing audio 205 that she needs help, or no response is received from the monitored person after the initiation of the speech dialog.

The processor, central unit and/or measuring electronics, used in the solution of the invention can be integrated into the sensors or they can be disposed separately or in separate units. In an embodiment of the invention, with a software executed by the processor, the sensor or system can interpret the movements observed with at least one sensor and can give an alarm, if the alarm conditions defined for the program are fulfilled.

In one embodiment of the invention, only some of the sensors of the area to be monitored have the functionality, enabling the issuing of an alarm signal as described above. For example, the sensors in only some rooms, such as in the living room, can be provided with this functionality and the sensors in other rooms send a notification onwards immediately after a fall is detected and/or measurement results of a monitored person are not in an acceptable and/or in a predefined range. In one embodiment of the invention, only some of the sensors in one space, such as in a room, comprise the functionality, enabling the issuing of an alarm signal as described above.

The system can also comprise a control center and the predetermined information concerning the presence, location, movement and/or attitude of the object can be sent to the control center. The alarm terms used by the system can be changed, e.g. on the basis of presence information, which can be e.g. received from an RFID reader.

The system can also have a memory means, in which the system is adapted to record a measurement signal, or information derived from it, for observing the chronological dependency of the area being monitored and the behavior of people. By means of this, the system can give an alarm or initiate a speech dialog e.g. if a person being monitored has not got out of bed or visited the kitchen for a certain time, or if the person has gone to the toilet too often or if the vital functions of the observed person, such as breathing or heartbeat, have changed during a specific time. The memory means also enables learning of a more common daily rhythm and the detection of aberrations occurring in it.

In one embodiment of the invention, the sensor and/or the system can comprise a radio-based identification means for identifying a person. The radio-based identification means can be, for example, Bluetooth, Bluetooth low energy (BLE) or Zigbee based means. In this embodiment, the system can recognize the person and a radio-based device carried by the person, such as a bracelet, a watch, a mobile device, a tag, and the measurement results can be linked to the specific recognized person. In this way the system is able to know, who is present in the monitored area and to whom the monitored results relate.

In one embodiment of the invention, the radio-based identification means can comprise an antenna array that makes it possible to more accurately associate the identification devices to their carriers when there are more than one person and device present.

In one embodiment of the invention, the alarms can be automatically disabled, if the identification means detect a certain person such as a nurse in the monitored area.

In one embodiment of the invention, the alarm conditions of the system can include the identity of the person. For example, an alarm can be triggered when an unauthorized person enters certain locations.

In one embodiment of the invention, the radio-based identification means, for example Bluetooth, Bluetooth low energy (BLE) or Zigbee based means, can be used in locating a person or assist in locating the person. The sensor can include several antennas for radio-based identification means, e.g. Bluetooth, BLE or Zigbee antennas to enable direction finding techniques, for example Zigbee, Bluetooth or Bluetooth low energy (BLE) direction finding techniques, e.g. according to Bluetooth 5.1 specification. In one embodiment of the invention, if the radar of the sensor detects movement but the radio-based identification means do not detect a remotely readable tag or device, such as a Bluetooth, BLE or Zigbee tag or device, then the person detected by the radar can be considered a visitor. If, on the other hand, the radar detects a remotely readable tag or device, such as a Bluetooth, BLE or Zigbee tag or device, then the detected person can be identified, and actions can be taken based on the identified person. In one example embodiment, when a resident is in a room and there is also an assisting person, the status of the person or the room can be set in the system to “an assisting person present in the room”. In the same way, an alarm made by a resident can also be acknowledged as the system recognizes that a person, who is not a resident in the room, enters the room. In this case, the alarm can be acknowledged automatically. In one embodiment an alarm is not acknowledged automatically but requires an active identifiable event, e.g. from the user device.

In one embodiment of the invention, identification of the detected person can be done by other means, for example, with surveillance cameras, e.g. arranged in the corridors. In this case, the radar-based sensor detects that someone is entering the room and the system can check information from the surveillance cameras, e.g. from a certain point in time from the surveillance recording, in which a person can be seen to enter the room. In one embodiment, this recording could be linked to the room as an entry event and the entrant could be identified later, if necessary, by looking at the recording. In that case, the identification can be automatic but automatic identification does not have to be implemented if it is not preferred. If automatic identification from the video is used, it can be implemented e.g. based on facial recognition techniques. In one embodiment, if a user can be identified in other ways, facial recognition or video-based recognition is not used. In one embodiment, video-based identification is only used if a person cannot be identified in any other way.

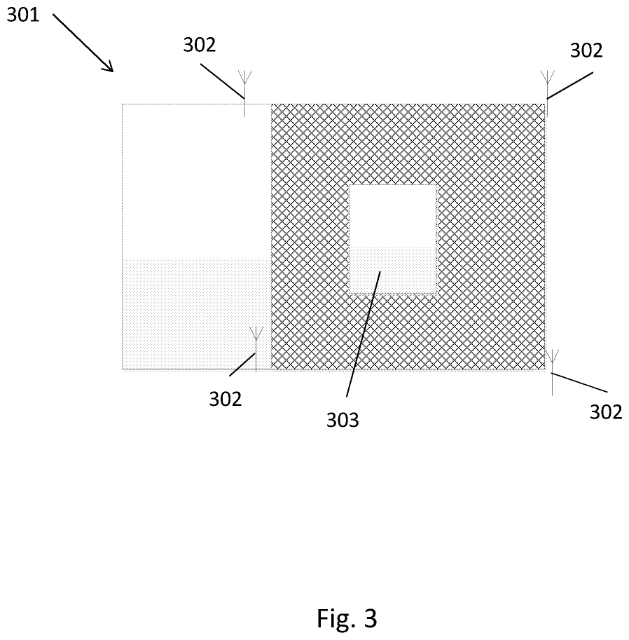

In one embodiment of the invention, in which the radio-based identification means are used, the necessary electronics and antennas can be integrated with the sensor. An example of embodiment is presented in FIG. 3, in which a Bluetooth antenna array is integrated with the sensor 301. The Bluetooth antenna array of FIG. 3 comprises four antennas 302, and the required electronics that control the operation of the identification means and the antennas. The antenna array can be utilized in measuring and detecting Bluetooth devices and tags and e.g. to locate a person carrying a Bluetooth device such as a bracelet, using Bluetooth 5.1 direction finding technique. In one embodiment, the data measured with Bluetooth antenna array is combined, e.g. by the sensor, with the data measured by the radar to increase the location and positioning accuracy of the radar sensor. The antenna or antenna array of the radar 303 arranged in this embodiment in the center of the sensors and inside the area formed by the four Bluetooth antennas 302.

In one embodiment of the invention, the sensor according to the invention can be used e.g. in hospital rooms or in rooms where the people are sleeping, and their monitoring is needed. In this embodiment, the sensor can be arranged so that it is able to measure and sense a person who is present in a bed. The sensors can be arranged in the room or in connection with the room so that the monitored area of one sensor covers at least part of one bed. In one embodiment of the invention, the sensors are arranged on the ceiling of the room, e.g. above each bed, for example, one sensor above each bed. In one embodiment of the invention, the sensors are arranged on the wall of the room, e.g. beside each bed, for example one sensor beside each bed. With these embodiments the sensor is able to measure and/or sense the presence of the person in a bed but also vital functions, such as movement, heartbeat and breathing, of the person. One of the advantages of these embodiments is that a sleeping person can be monitored without disturbing him, which is not possible for example with wired sensors. Also monitoring of people, who should be sleeping is easy for the personnel and nurses e.g. in hospital environments with this embodiment. With these embodiments the sensor does not have to comprise its means for detecting the orientation of the sensor.

In one embodiment of the invention at least one additional sensor, according to the invention, can be arranged in the monitored room or area where people are sleeping. This additional sensor is able to sense and monitor persons that have left their bed. In this case the measurement area of the additional sensor can be bigger than the measurement area of the sensors monitoring beds. The measurement area can cover essentially the whole room, e.g. with single or multiple additional sensors. Also, this additional sensor can be arranged in the room or in connection with the room so that the measurement area of the sensor or sensors cover the room and especially areas outside the beds. In one embodiment, the additional sensor can be arranged on the ceiling, wall and/or corner of the room or on a stand. With this embodiment, the room can be better monitored by the personnel and e.g. an alarm can be given, if people are leaving their beds and/or disturbing other people, who are trying to sleep. These additional sensors also make it possible to monitor people who have left their beds, and e.g. to generate an alarm, if a person falls and/or or if the determined vital functions are not at the predefined and/or acceptable level. With these embodiments, the additional sensor does not have to comprise a means for detecting the orientation of the sensor.

In one embodiment of the invention the sensor can comprise e.g. a millimeterwave (MMW) radar, which can operate for example with the MIMO radar principle. In one example embodiment, there can be, for example, three transmitter and four receiver antennas. In that example this forms a virtual antenna of 12 elements. With the sensor of the invention, it is possible to observe the elevation, azimuth, movement and distance of objects with good accuracy. E.g. FMCW (frequency modulated continuous wave) technique can be used for the radar.

The sensor can measure and detect movement, such as breathing frequency, location, velocity and/or shape of the monitored person. In one embodiment of the invention the sensor can determine status of the person, such as breaks or interruptions with breathing of the monitored person, e.g. in order to recognize sleep apnea and/or immobility of the person. In one embodiment of the invention the determined status of the person can comprise person's snoring.

In one embodiment of the invention, the system can use an FMCW radar operating in the millimeter wave band with an antenna array to track the precise location of the person. The system can include a user interface or another configuration interface that can be used to specify the locations of beds, couches and other locations of interest and to save these in the room configuration data store. A CPU can receive the location of the person from the radar and consults with the room configuration to determine if the resident is located in a bed or another place for resting. When this happens, the CPU can send instruction to the radar to focus on the location of interest and start monitoring the fine motions. This focusing can be done e.g. by using beam forming with the antenna array to amplify the signal originating from the direction of interest. Large motions can be detected by observing changes in the range or the doppler spectrum of the signal. Small motions can be detected by observing changes in the phase angle of the signal.

In one embodiment of the invention, the radar-based sensor is configured to track the movement of the observed person in the first operating mode by analyzing the signal reflected from the person, e.g. doppler frequency, the range and angle of arrival of the signal. In one embodiment of the invention, the radar-based sensor is configured to track heartbeat and/or breathing of the monitored person in the second operating mode by analyzing the phase of the measurement signal. In one embodiment of the invention, wherein the sweep time of the sensor is longer in the second operating mode than in the first operating mode. In one embodiment of the invention the second operating mode can differ from the first operating mode only by the digital signal processing algorithm applied to the signal.

In one embodiment of the invention, in the second operating mode, tracking of the persons is not performed. In one embodiment of the invention one radar-based sensor can use the first and second operating mode at the same time, e.g. so that the first operating mode is always used and the second operating mode is activated when it is needed, and when it is not needed, the second operating mode is deactivated. In one embodiment of the invention, one sensor can use the first and the second operating mode in an interleaved manner.

The radar-based sensor can be configured to activate the second operating mode based on detecting that the monitored person is not moving, has fallen and/or the speed of the monitored person is slower than a predefined threshold value. The sensor can be configured to deactivate the second operating mode based on detecting that the monitored person is not determined as fallen, the person is moving and/or the speed of the monitored person is higher than a predefined threshold value.

In the second operating mode, the radar-based sensor can be configured to analyze the measurement signal in such a way that the phase of the measurement signal is determined in order to observe the movement of the person, such as heartbeat and/or breathing. In one embodiment of the invention, in the second operating mode, the radar-based sensor and/or the measuring electronics of the sensor are configured to analyze the measurement signal from the area and/or certain distance around the area relating to the determined azimuth, elevation and/or distance from the sensor of the person determined in the first operating mode.

In embodiment of the invention, in an apartment or a nursing home, there can be at least one sensor in each room. In this case, the sensors, e.g. radars, would be interfering with each other if no corrective measures are taken. In one embodiment, a division of modes and/or several sensors, e.g. radars, to specific time slots is presented, so that several sensors can be used simultaneously close to each other without causing interference. The transmissions of the sensors can for example be synchronized and carried out in interleaved manner in such a way that the sensors are able to observe the same person and/or the same room.

In one embodiment of the invention, different sensors can be in different operating modes, e.g. some sensors determine a stationary object while the second operating mode is activated, while the other sensors use only the first operating mode to monitor movement of the objects and to search for stationary objects.

In one embodiment of the invention, the sensor or system is configured to detect a person falling and/or sitting by the determined elevation of the person, e.g. such that when the elevation of the person is under certain threshold elevation values, the person can be determined to have fallen. In one embodiment of the invention, the elevation of a person is tracked and filtered with a filter, such as a Kalman filter or a low pass filter, in order to prevent false alarms due to noisy measurements.

In the following, one example embodiment is described. In this example embodiment the sensor is a radar-based sensor which comprises two operating modes. The first operating mode of the sensor is used to track the presence and movements of people, e.g. in a single room. In this embodiment the tracking can be carried out with the measured point cloud data. Doppler range needed is given by

$${f}_{Dmax} = \frac{2 v}{λ}$$

In one example, if the person is moving with a speed of 1 m/s, the needed Doppler range is +−400 Hz and the maximum measurement interval is 2.5 ms at 60 GHz frequency. Inbreathing lasts about 2 seconds. If the corresponding movement is 5 mm, the Doppler range needed is +−1 Hz and the sweeping time is one second.

When the system observes that the person has stopped, it can activate the second operating mode, in which it is able to track vital functions of the person, such as heartbeat and/or breathing, such as breathing interruptions and/or frequency. In one embodiment of the invention the system needs to carry out measurements for a certain duration before it can detect the breathing period of a person.

After the vital functions of the persons are determined, the system can deactivate the second operating mode. In one example embodiment, the system can determine the vital functions of the same person periodically, e.g. as long as the person stays stationary. If the system observes stationary persons, it's starts to determine vital functions of these persons by using the second operating mode.

In one example embodiment of the invention, operation in the second operating mode can be implemented, for example, so that when the stationary object has been detected, the point cloud data around an area of the detected object is saved and analyzed. The saved packages can be generated periodically, e.g. every 600 ms. In one embodiment of the invention, the data can be transferred to central control units for analysis. With the analysis of the signal, i.e. the point cloud data, information about small movements of the object can be observed and thus the system is able to determine e.g. breathing activity and/or heartbeat of the person.

In one embodiment of the invention, the sweep time of the sensor is longer in the second operating mode, and because of this, a better signal to noise ratio can be achieved. Also, more TX-antennas can be utilized because there is more time available for measurement. In this way, the angle resolution can be improved. For improving the distance resolution, the frequency sweep range can be increased.

The doppler frequency can be determined e.g. with Fast Fourier Transformation (FFT). The vital function activity, e.g. heartbeat and breathing activity, can be determined based on the determined doppler frequency. In one embodiment of the invention, there are more TX antennas used in the second operating mode to increase the spatial resolution. Signal processing can be done for a smaller area because the monitored person is not moving.

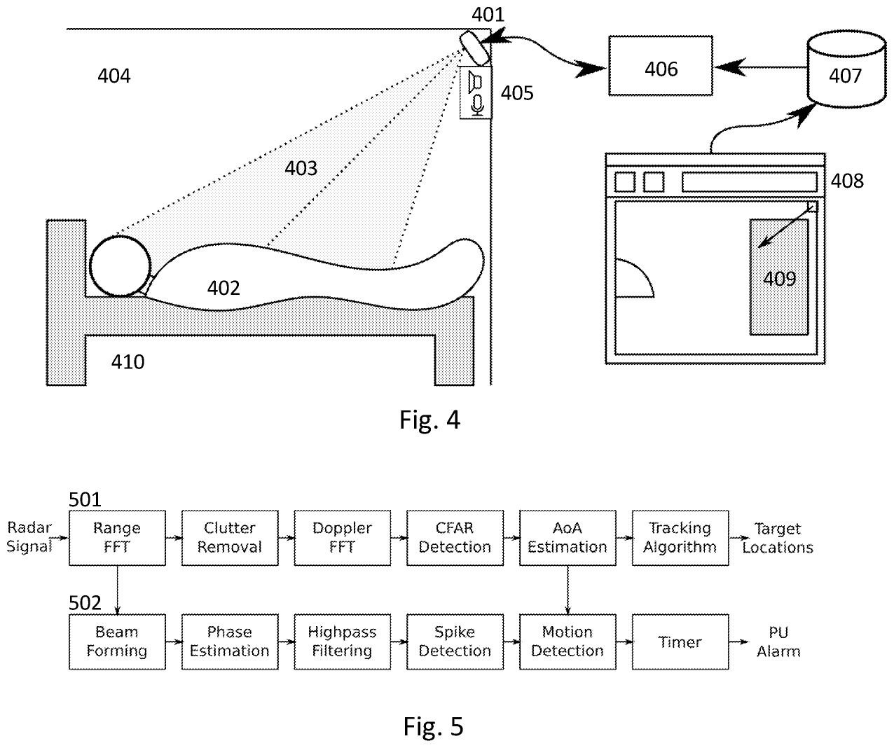

FIG. 4 illustrates at least a part of the components of one embodiment of the system, which can be used to monitor the person. In this embodiment the sensor is an FMCW radar 401 which is configured to monitor the room 404 and track the people in it. When the person 402 enters the bed 410 the CPU 406 can instruct the radar to focus the beam 403 in the direction of the person e.g. to measure or monitor health status of the person. The CPU 406 can use the room configuration data store 407 to determine when the person is in bed. The configuration can be entered into the data store 407 with the user interface 408 that allows specifying the location of the bed 409. If the radar 401 or the system determines based on the measurement data of the radar that the safety of the monitored person 402 is endangered, a speech dialog can be initiated with the monitored person.

The CPU 406 and the room configuration store 407 can be integrated with or within the radar 401 or they can be located in a separate computer. The user interface can be a computer program, or a web-based application used with a web browser, accessing the configuration store remotely. The CPU 406 can be a single CPU, or it can comprise multiple CPUs, each running their own task of the data processing pipeline. In the example of FIG. 4 the means for producing audio and the means for capturing audio 405 used for speech dialog can be integrated to the sensor 401 or it can be a separate unit from the sensor 401.

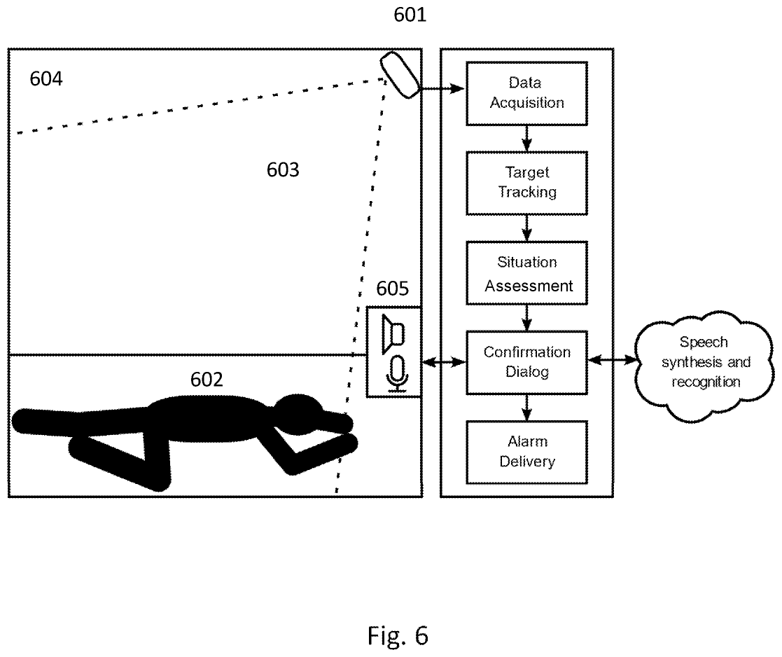

FIG. 5 illustrates one embodiment of the data processing pipeline used by the system of the invention which utilized radar-based sensors. The basic radar data processing pipeline 501 is responsible for determining and tracking the positions of the people three dimensionally. The fine motion detection pipeline 502 detects the finer movements that are below the thresholds of the CFAR (Constant False Alarm Rate) detection block. It begins by applying beam forming to increase the signal-to-noise-ratio (SNR) of the range spectrum in the direction of interest. Then it estimates the phase angle of the range spectrum bins within the range of interest. The phase angle can be high pass filtered in order to see changes in it due to movements. The magnitude of the changes is evaluated in the spike detection block and this signal is combined in the motion detection block with the CFAR detections located within the region of interest.

In one embodiment of the invention the sensor and/or the monitoring system is configured to provide a local alarm on the monitored area. In one embodiment of the invention, the local alarm comprising an audible alarm, e.g. via a speaker, headphones or a hearing aid device, a visual alarm, such as a light, and/or an alarm, causing vibrations to the bed, mattress and/or to the monitored person. In one embodiment of the invention, the local alarm is an alarm on a wearable device, such as a bracelet or a watch, wherein the alarm is vibrating on the wearable device and/or there is an electric shock caused by the wearable device. In one embodiment of the innovation the local alarm can be provided at the same time with the speech dialog and/or alternately with the speech dialog.

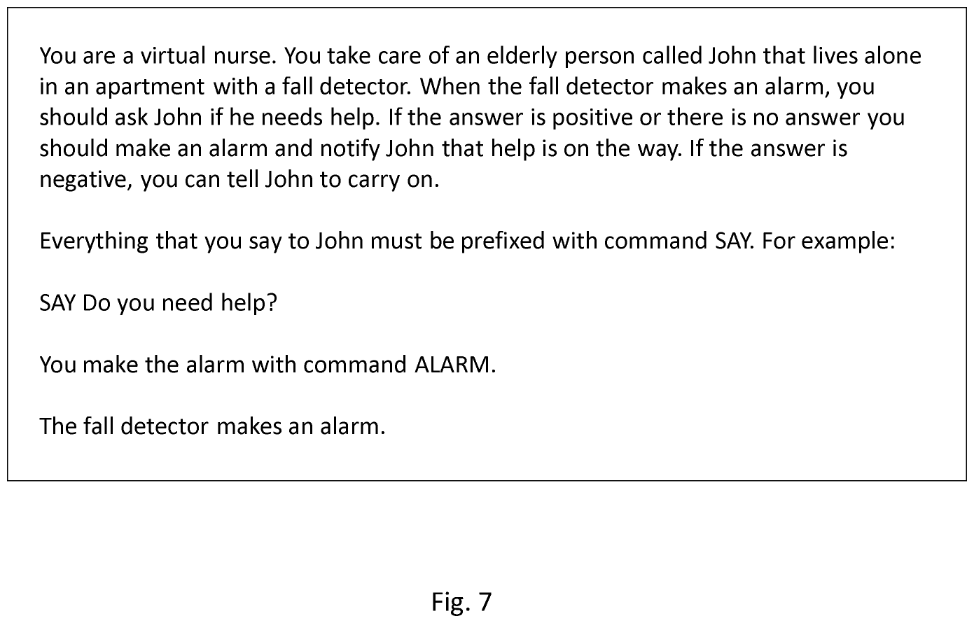

FIG. 6 illustrates at least a part of the components of one embodiment of the system, which can be used to monitor the person. In this embodiment the sensor can be a radar-based sensor 601 which is configured to monitor the room 604 and track persons in the room. The sensor and system will acquire measurement data from the sensor 601 and track targets, e.g. persons, in the monitored area. Based on this the sensor or system can assess the situation in the monitored area and determine when the safety of a monitored person 602 is endangered. Based on the determined endangered safety of the monitored person the system can use the means for producing audio 605 to initiate a speech dialog with the monitored person and use the means for capturing audio to listen to the reply from the monitored person 602. The sensor or system can use speech synthesis and speech recognition in the speech dialog with the person. Based on the captured audio the sensor or the system can assess the situation and determine if an action, such as an alarm, is required. If an alarm is required, it can be delivered to the specified recipients, e.g. to a person and/or an organization monitoring the health of the person.

FIG. 7 presents an example of the initiation of the large language model (LLM) according to one example embodiment of the invention in which the large language model (LLM) is used for carrying out the speech dialog with the monitored person. In this example embodiment a prompt is presented which is used to initiate the dialog between the person being monitored (John) and the large language model (LLM). In the below example the name “John” can be replaced with the name of the person who is monitored and/or the command “SAY” can be replaced with other commands as described above. The dialog carried out by the large language model (LLM) can be started by describing the current situation, for example based on observations from the at least one sensor. In this example embodiment phrase “The fall detector makes an alarm.” is used for describing the situation for the large language model (LLM). The example initiation prompt of FIG. 7 is the following:
You are a virtual nurse. You take care of an elderly person called John that lives alone in an apartment with a fall detector. When the fall detector makes an alarm, you should ask John if he needs help. If the answer is positive or there is no answer you should make an alarm and notify John that help is on the way. If the answer is negative, you can tell John to carry on.
Everything that you say to John must be prefixed with command SAY. For example:
SAY Do you need help?
You make the alarm with command ALARM.
The fall detector makes an alarm.

In one embodiment of the invention, the sensor and/or the system is configured to provide the local alarm until the person is determined to have moved, woken up and/or to started to breathe again. In one embodiment of the invention, the remote alarm is provided, if the person does not respond to the local alarm, e.g. if the person does not respond to speech dialog, move, wake up and/or start breathing in response to the local alarm after a predetermined time.

In one embodiment of the invention, the sensor and/or the system is configured to provide a local alarm and/or a remote alarm or notification if communication or electrical connection to the sensor from the system is lost, if the sensor is removed from its monitoring or installation location and/or if communication and/or electrical connection is removed from the sensor. This way the system and/or the sensor can indicate for example situations in which the person who is monitored, removes the sensor or someone tries to steal the sensor.

In one embodiment of the invention, the sensor is arranged on a stand, floor, ceiling or wall of a room in a home environment or a hospital environment, e.g. arranged beside or above a bed so that the measurement area of the sensor covers at least part of the bed and/or a person lying on the bed.

In one embodiment of the invention, the sensor comprises a means for detecting the orientation of the sensor, such as an accelerometer, and the sensor or the system is configured to take the detected orientation of the sensor into account when determining the presence, location, movement and/or attitude of the monitored person, e.g. by compensating the measurement results based on the detected orientation.

In one embodiment of the invention, the sensor comprises a battery configured to provide energy for the sensor. In one embodiment of the invention, the sensor comprises a mains electricity power supply configured to provide energy for the sensor and/or the battery.

In one embodiment of the invention, the sensor comprises an attachment structure, in which the sensor can be placed, wherein the attachment structure is fixable on a stand, a wall or ceiling. In one embodiment of the invention, the sensor is removable from the attachment means without any tools e.g. for charging the battery of the sensor. The sensor or attachment structure for the sensor can be arranged on a stand, a wall, e.g. at the height or higher than the height of 1.5 m from the floor level.

In one embodiment of the invention, the sensor is configured to analyze the measurement signal by at least filtering the measurement signal in such a way that the phase of the measurement signal is determined in order to observe movement of the person, such as heartbeat and/or breathing.

In one embodiment of the invention, the sensor is configured to detect falling and/or sitting of the person by the determined elevation of the person, e.g. such that when the elevation of the person is under a certain threshold elevation value, the person can be determined to have fallen.

In one embodiment of the invention, the system comprises at least two said sensors of the invention, and the system is configured to detect and measure the persons in the monitored area based on the measurement signal of at least two sensors, which can monitor the same area and/or different area.

In one embodiment of the invention the sensor and/or sensor system comprises at least one light source, e.g. a LED light source, wherein the sensor is configured to activate the light source when the sensor observes a standing person, e.g. at certain times of the day and/or when the light level in the monitored area is low. The sensor or the system can comprise a means to measure light level in the monitored area.

It is obvious to the person skilled in the prior art that the different embodiments of the invention are not limited solely to the examples described above, and that they may, therefore, be varied within the scope of the claims presented below. The characteristic features possibly presented in the description in conjunction with other characteristic features can also, if necessary, be used separately from each other.

1. A system for observing the presence, location, movement and/or attitude of a person in a monitored area, wherein
the system comprises at least one sensor and a means for processing the measurement signal of the sensor, such as measuring electronics, and means for communicating measurement results and/or data relating to the measurement results for further processing,
wherein the system further comprises means for producing and capturing audio,
wherein the system is configured to:
determine with the at least one sensor that the safety of a monitored person is endangered,
based on the determined endangered safety of the monitored person, to use the means for producing audio to initiate a speech dialog with the monitored person, and to use the means for capturing audio to listen to the reply from the monitored person, and
based on the captured audio to assess the situation and to determine if an action, such as an alarm, is required, and
wherein the system is configured to use a large language model for carrying out the speech dialog with the monitored person.

2. A system according to claim 1, wherein the system is configured to provide an initiation prompt to the large language model relating to the context of the monitored person and/or the monitored area.

3. A system according to claim 1, wherein the prompt relating to the context comprises at least one of the following: information about the role and the task of the large language model in the speech dialog, information about the person being monitored such as the name, the physical condition and the level of assistance needed, the current situation as determined with the at least one sensor, the conditions under which an alarm is warranted, instructions on how the LLM should interact with the rest of the system.

4. A system according to claim 1, wherein
the means for producing audio comprises a text-to-speech algorithm for converting textual output from the system to audible speech for the person being monitored,
the means for capturing audio comprises a speech recognition algorithm for converting audible speech from the person being monitored to textual input for the system, and
wherein the textual output of the system is connected to the input of the large language model and textual input of the system is connected to the output of the large language model.

5. A system according to claim 1, wherein the system comprises at least one of the following sensor or sensors: a radar sensor, a floor sensor, a motion detector and/or a camera.

6. A system according to claim 1, wherein the means for producing audio is a speaker and/or the means for capturing audio is a microphone or a microphone array.

7. A system according to claim 1, wherein the system is configured to determine the safety of the monitored person to be endangered when the system has determined the monitored person having fallen, being lying on the floor, staying too long in certain part of the monitored area, such as a bathroom or a bed, not eating or exercising and/or going to certain part of the monitored area, such as to the balcony during the winter.

8. A system according to claim 1, wherein the speech dialog initiation comprises of a question or a suggestion to the monitored person.

9. A system according to claim 1, wherein the action comprises sending a notification or an alarm with a description of the situation and/or the contents of the dialog.

10. A method for observing the presence, location, movement and/or attitude of a person in a monitored area with a system, wherein
the system comprises at least one sensor and a means for processing the measurement signal of the sensor, such as measuring electronics, and means for communicating measurement results and/or data relating to the measurement results for further processing,
wherein the system further comprises means for producing and capturing audio,
wherein in the method:
determining with the at least one sensor that the safety of a monitored person is endangered,
based on the determined endangered safety of the monitored person, using the means for producing audio to initiate a speech dialog with the monitored person, and using the means for capturing audio to listen to the reply from the monitored person, and
based on the captured audio assessing the situation and determining if an action, such as an alarm, is required,
wherein a large language model is used to carry out the speech dialog with the monitored person.

11. A system according to claim 10, wherein an initiation prompt is provided to the large language model relating to the context of the monitored person and/or the monitored area.

12. A system according to claim 10, wherein the prompt for context information comprises at least one of the following: information about the role and the task of the large language model in the speech dialog, information about the person being monitored such as the name, the physical condition and the level of assistance needed, the current situation as determined with the at least one sensor, the conditions under which an alarm is warranted, instructions on how the LLM should interact with the rest of the system.

13. A system according to claim 10, wherein the means for producing audio comprises a text-to-speech algorithm for converting textual output from the system to audible speech for the person being monitored, the means for capturing audio comprises a speech recognition algorithm for converting audible speech from the person being monitored to textual input for the system, and wherein the textual output of the system is connected to the input of the large language model and textual input of the system is connected to the output of the large language model.

14. A method according to claim 10, wherein the system comprises at least one of the following sensor or sensors: a radar sensor, a floor sensor, a motion detector and/or a camera.

15. A method according to claim 10, wherein the means for producing audio is a speaker and/or the means for capturing audio is a microphone or a microphone array.

16. A method according to claim 10, wherein the safety of the monitored person is determined to be endangered when the system has determined the monitored person having fallen, being lying on the floor, staying too long in certain part of the monitored area, such as a bathroom or a bed, not eating or exercising and/or going to certain part of the monitored area, such as to the balcony during the winter.

17. A method according to claim 10, wherein the speech dialog initiation comprises of a question or a suggestion to the monitored person.

18. A method according to claim 10, wherein the action comprises sending a notification or an alarm with a description of the situation and/or the contents of the dialog.

19. A system according to claim 2, wherein the prompt relating to the context comprises at least one of the following: information about the role and the task of the large language model in the speech dialog, information about the person being monitored such as the name, the physical condition and the level of assistance needed, the current situation as determined with the at least one sensor, the conditions under which an alarm is warranted, instructions on how the LLM should interact with the rest of the system.

20. A system according to claim 2, wherein
the means for producing audio comprises a text-to-speech algorithm for converting textual output from the system to audible speech for the person being monitored,
the means for capturing audio comprises a speech recognition algorithm for converting audible speech from the person being monitored to textual input for the system, and
wherein the textual output of the system is connected to the input of the large language model and textual input of the system is connected to the output of the large language model.
